(19) United States
(12) Patent Application Publication
(10) Pub. No.: US 2017/0134128 A1
(43) Pub. Date: May 11, 2017

(54) SUPPORT OF OTDOA POSITIONING USING MIXED TRANSMISSION PORT ANTENNA CONFIGURATIONS

(71) Applicant: QUALCOMM Incorporated, San Diego, CA (US)

(72) Inventors: Guttorm Opshaug, Redwood City, CA (US); Shenqiu Zhang, Sunnyvale, CA (US); Mariam Motamed, Redwood City, CA (US); Borislav Ristic, Del Mar, CA (US)

(21) Appl. No.: 15/258,894

(22) Filed: Sep. 7, 2016

Related U.S. Application Data
(60) Provisional application No. 62/251,614, filed on Nov. 5, 2015.

(51) Int. Cl. H04L 5/00; G01S 5/02; H04B 17/318

(52) U.S. Cl. CPC H04L 5/0048; H04B 17/318; G01S 5/0252; G01S 5/0236

(57) ABSTRACT

Disclosed are devices and methods at a mobile device for processing a first downlink signal transmitted from a first cell transceiver in the presence of one or more second cell transceivers transmitting a second downlink signal using a four antenna port configuration. In an embodiment, the mobile device may process the first downlink signal so as to ameliorate effects of interference or jamming introduced by the second downlink signal.

### CROSS-REFERENCE TO RELATED APPLICATIONS

This application claims the benefit of U.S. Provisional Application No. 62/251,614, entitled “Support of OTDOA Positioning Using Mixed Transmission Port Antenna Configurations,” filed Nov. 5, 2015, which is assigned to the assignee hereof and which is expressly incorporated herein by reference.

### BACKGROUND

Wireless communication systems have developed through various generations, including a first-generation analog wireless phone service (1G), a second-generation (2G) digital wireless phone service (including interim 2.5G networks) and third-generation (3G) and fourth-generation (4G) high speed data/Internet-capable wireless services.

More recently, Long Term Evolution (LTE) has been developed by the 3^{rd} Generation Partnership Project (3GPP) as a radio access network technology for wireless communication of high-speed data and packetized voice for mobile phones and other mobile terminals. LTE has evolved from the Global System for Mobile Communications (GSM) system and from derivatives of GSM, such as Enhanced Data rates for GSM Evolution (EDGE), Universal Mobile Telecommunications System (UMTS), and High-Speed Packet Access (HSPA).

In North America, wireless communications systems, such as LTE, use a solution for Enhanced 911, or E911, that links emergency callers with the appropriate public resources. The solution attempts to automatically associate the caller, i.e., the caller's user equipment (UE), with a specific location, such as a physical address or geographic coordinates. Automatically locating the caller with high accuracy (e.g., with a distance error of 50 meters or less) and providing the location to a Public Safety Answering Point (PSAP) can increase the speed with which the public safety side can locate the required resources during emergencies, especially where the caller may be unable to communicate his/her location (e.g., does not know the location or is unable to speak adequately).

To locate a UE geographically, there are several approaches. One is to use some form of terrestrial radio location based on measurements made by a UE of signals transmitted by wireless network base stations and access points (APs) and/or based on measurements made by network elements (e.g., base stations and/or APs) of signals transmitted by the UE. Another approach is to use a Global Positioning System (GPS) receiver or Global Navigation Satellite System (GNSS) receiver built into the UE itself. Terrestrial radio location in a cellular telephony system may use measurements made by a UE of transmission timing differences between pairs of base stations or APs and may employ trilateration or multilateration techniques to determine the position of the UE based on two, or more commonly three or more, timing difference measurements.

One such terrestrial radio location method that is applicable to measurements of LTE base stations (referred to as eNodeBs or eNBs) and that is standardized by 3GPP in 3GPP Technical Specifications (TSs) 36.211, 36.305, and 36.355 is Observed Time Difference of Arrival (OTDOA). OTDOA is a multilateration method in which a UE measures the time difference between specific signals from several eNodeBs and either computes a location itself from these measurements or reports the measured time differences to an Enhanced Serving Mobile Location Center (E-SMLC) or to a Secure User Plane Location (SUPL) Location Platform (SLP), which then computes the UE's location. In either case, the measured time differences and knowledge of the eNodeBs' locations and relative transmission timing are used to calculate the UE's position. Another position method that is similar to OTDOA (in measuring time differences between different base stations at a UE) is known as Advanced Forward Link Trilateration (AFLT) which may be used to a locate a UE that is accessing a CDMA2000 network as defined by the 3^{rd} Generation Partnership Project 2 (3GPP2).

In OTDOA and AFLT based positioning methods, a UE may measure time differences for signals received from one or more base stations and/or APs within a communication network. Location information for the measured base stations and APs may include parameters regarding their locations (e.g., location coordinates) and transmission characteristics (e.g. transmission timing, transmission power, signal content and characteristics) and may be referred to as an almanac, a base station almanac (BSA), almanac data or BSA data. The observed time differences measured by a UE (e.g., for OTDOA or AFLT) may be used in conjunction with known BSA for the measured base stations (e.g., eNodeBs) and/or APs to calculate a position for the UE either by the UE or by a location server such as an E-SMLC or SLP.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a block diagram of components of one embodiment of a user equipment;

FIG. 2 is an example architecture for terrestrial positioning with 3GPP long term evolution (LTE) access;

FIG. 3 is a schematic diagram of an architecture of an example wireless communication network for support positioning according to an embodiment;

FIG. 4A is a message flow diagram of an example Long-Term Evolution (LTE) position protocol (LPP) for supporting positioning according to an embodiment;

FIG. 4B is a flow diagram of a process according to an embodiment.

FIG. 5 is an example mapping of symbols in frequency bins of normal cyclic pre-fix (NCP) Positioning Reference Signal (PRS) and cell-specific reference signal (CRS) for a one or two antenna port eNode B transmitter according to an embodiment;

FIG. 6 is an example mapping of symbols in frequency bins of NCP PRS and CRS for a four-antenna port eNode B transmitter according to an embodiment;

FIG. 7 is an example mapping of symbols in frequency bins of extended cyclic pre-fix (ECP) PRS and CRS for a one or two antenna port eNode B transmitter according to an embodiment;

FIG. 8 is an example mapping of symbols in frequency bins of ECP PRS and CRS for a four-antenna port eNode B transmitter according to an embodiment; and

FIG. 9 is a block diagram of components of one embodiment of a computer system for use in positioning using ambiguous cells.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### SUMMARY

Briefly, particular implementations are directed to method at a user equipment comprising: receiving a first downlink signal from a first cell transceiver, the first cell transceiver transmitting the first downlink signal using a one or two antenna port configuration, the first downlink signal comprising a positioning reference signal (PRS); and selectively affecting processing of the PRS of the first downlink signal in a presence of one or more second cell transceivers transmitting a second downlink signal using a four antenna port configuration.

Another particular implementation is directed to a user equipment (UE) comprising: a wireless transceiver; and a processor coupled to the wireless transceiver configured to: obtain at least a portion of a first downlink signal received at the wireless transceiver from a first cell transceiver, the first cell transceiver transmitting the first downlink signal using a one or two antenna port configuration, the first downlink signal comprising a positioning reference signal (PRS); and selectively affect processing of the PRS of the first downlink signal in a presence of one or more second cell transceivers transmitting a second downlink signal using a four antenna port configuration.

Another particular implementation is directed to a non-transitory storage medium comprising computer readable instructions stored thereon which are executable by a processor of a user equipment (UE) to: obtain at least a portion of a first downlink signal received at the UE from a first cell transceiver, the first cell transceiver transmitting the first downlink signal using a one or two antenna port configuration, the first downlink signal comprising a first positioning reference signal (PRS); and selectively affect processing of the PRS of the first downlink signal in a presence of one or more second cell transceivers transmitting a second downlink signal using a four antenna port configuration.

Another particular implementation is directed to a user equipment (UE) comprising: means for receiving a first downlink signal from a first cell transceiver, the first cell transceiver transmitting the first downlink signal using a one or two antenna port configuration, the first downlink signal comprising a first positioning reference signal (PRS); and means for selectively affecting processing of the PRS of the first downlink signal in a presence of one or more second cell transceivers transmitting a second downlink signal using a four antenna port configuration.

It should be understood that the aforementioned implementations are merely example implementations, and that claimed subject matter is not necessarily limited to any particular aspect of these example implementations.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the patent application, particular context of description and/or usage provides helpful guidance regarding reasonable inferences to be drawn; however, likewise, “in this context” in general without further qualification refers to the context of the present patent application.

Techniques are discussed for supporting positioning by acquisition of radio signals According to an embodiment, a wireless communication network may contain one or more cellular transceivers that employ one or more antennas, one or more Remote Radio Heads (RRHs), repeaters or relays, or that broadcasts the same Positioning Reference Signal (PRS). A mobile device comprising a receiver may obtain observations of PRSs transmitted by one or more nearby cell transceivers such as, for example, a time of arrival (TOA) or reference signal time difference (RSTD) measurement. Based, at least in part, on observations of times of arrival of PRSs transmitted from three or more PRSs, an estimated location of the mobile device may be computed using any one of several techniques including, for example, OTDOA.

According to an embodiment, a PRS may be transmitted in a downlink by a cell transceiver using a one or two antenna port configuration or a four antenna port configuration. In certain scenarios, portions of a first downlink signal transmitted by a first cell transceiver using a four antenna port configuration may interfere with or jam at a receiver with a portion of a PRS transmitted in a second downlink signal using a four antenna port configuration. In particular implementations, processing at a receiver of a PRS transmitted in a first downlink signal by a first cell transceiver using a one or two antenna port configuration may be altered in the presence of a second cell transceiver transmitting a second downlink signal using a four antenna port configuration.

A UE may obtain observations of a sufficient number of PRS' transmitted from different locations to compute a position fix. Positioning assistance data may be provided to the UE such that the positioning assistance data (e.g., including an indication of a plurality of cell transceivers) may be provided along with a request for measurements. The UE may be configured to access a Long Term Evolution (LTE) network and the at least one observation of a PRS transmitted by a cell transceiver. Such an observation may comprise a RSTD measurement for an Observed Time Difference of Arrival (OTDOA) positioning method. The cell transceiver may comprise a reference cell or a neighbor cell. Providing the positioning assistance data to the UE may include sending an LTE Positioning Protocol (LPP) Provide Assistance Data message to the UE. A serving cell may receive measurement data from the UE via an LPP Provide Location Information message from the UE. Calculating the current position of the UE may be based on almanac data.

Items and/or techniques described herein may provide one or more of the following capabilities, as well as other capabilities not mentioned. Positioning assistance data including an indication of a plurality of cell transceivers may be provided from a location server to a UE. The UE may determine RSTD measurements based on the positioning assistance data. In this context, “positioning assistance data” or “positioning assistance parameters” comprises one or more values, parameters, indications, inferences, etc., that may be applied by a mobile device in obtaining an estimated location of the mobile device, or in obtaining one or more measurements that are indicative of a location of the mobile device. In this context, positioning assistance data or positioning assistance parameters comprises a signal stored in a memory as a memory state or signal representing values, parameters, indications, inferences, etc. In one implementation, positioning assistance data may be provided to a mobile device in one or more messages from a location server. However, this is merely an example of how a mobile device may obtain positioning assistance data and claimed subject matter is not limited in this respect. A location server, or a UE, may process the RSTD measurements to determine a current location estimate for the UE. The current location estimate may be based at least in part on RSTD measurements obtained from PRS' acquired from one or more cells.

A client device, referred to herein as a user equipment (UE), may be mobile or stationary, and may communicate with a radio access network (RAN). As used herein, the term “UE” may be referred to interchangeably as an “access terminal” or “AT”, a “wireless device”, a “subscriber device”, a “mobile device”, a “subscriber terminal”, a “subscriber station”, a “user terminal” or UT, a “mobile terminal”, a “mobile station”, a SUPL enabled terminal (SET), a target device, a target UE, and variations thereof. A UE may comprise a cell phone, smart phone, laptop, tablet, asset tag, PDA or any other device that is enabled to communicate wirelessly with other UEs and/or other entities via direct means and/or via one or more networks or one or more network elements. In an embodiment, UEs may communicate with a core network via a RAN, and through the core network (or sometimes through the RAN) the UEs may be connected with external networks such as the Internet. The RAN may support wireless communication from UEs using cellular based radio technologies such as GSM, UMTS and LTE as defined by 3GPP or CDMA2000 as defined by 3GPP2. A UE may also employ other mechanisms for connecting to the core network and/or the Internet such as over wired access networks, WiFi networks (e.g., based on IEEE 802.11, etc.), Bluetooth® networks and so on. UEs may be embodied by any of a number of types of devices including but not limited to PC cards, compact flash devices, external or internal modems, wireless or wireline phones, and so on. A communication link through which UEs may transmit signals to the RAN may be referred to as an “uplink” channel (e.g., a reverse traffic channel, a reverse control channel, an access channel, etc.). A communication link through which the RAN can send signals to UEs may be referred to as a “downlink channel” or “forward link channel” (e.g., a paging channel, a control channel, a broadcast channel, a forward traffic channel, etc.), and may be transmitted in a “downlink signal.”

An estimated location of a UE may be referred to as a location estimate, position, position estimate, position fix or fix or by some other name and may be expressed as location coordinates such as a latitude, longitude and possibly altitude. In some cases, location coordinates may be local and may then sometimes be referred to as x, y and z (or X, Y and Z) coordinates where an x (or X) coordinate refers to a horizontal distance in a particular direction (e.g. a distance East or West of a given known origin), a y (or Y) coordinate refers to a horizontal distance at right angles to the x (or X) direction (e.g., a distance North or South of a given known origin) and a z (or Z) coordinate refers to a vertical distance (e.g., a distance above or below local ground level). When computing the location of a UE, it is common to solve for local x, y and possibly z coordinates and then, if needed, convert the local coordinates into absolute ones (e.g., for latitude, longitude and altitude above or below mean sea level).

According to an embodiment, a UE may operate in an environment in which cell transceivers employ a diversity of antenna configurations to transmit a downlink signal such as, for example, employing a different numbers of antenna ports and associated PRS encoding. In an example implementation, a first PRS in a first downlink signal transmitted by a first cell transceiver using four antenna ports may jam or interfere at a UE with at least a portion of a second PRS in a second downlink signal transmitted by a second cell transceiver. As discussed below in particular implementations, to address interference/jamming processing of a PRS transmitted in a first downlink signal using one or two antenna ports at a UE may be affected or altered in the presence of one or more downlink signals transmitted in a second downlink signal using four antenna ports.

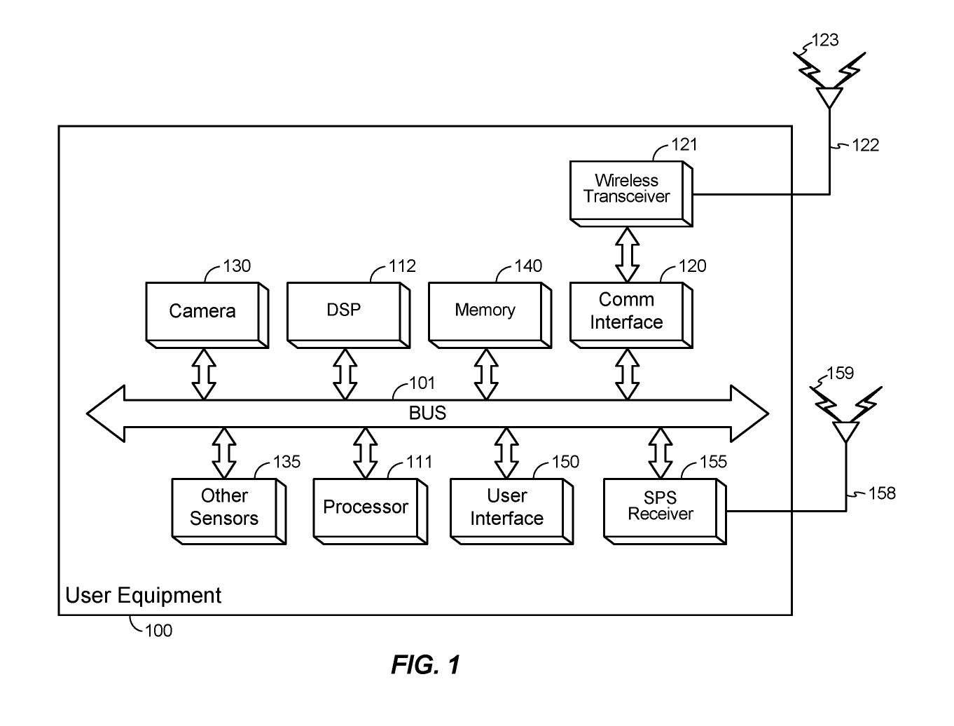

Referring to FIG. 1, a user equipment (UE) 100 is illustrated for which various techniques herein can be utilized. The UE 100 includes a processor 111 (or processor core) and memory 140. The UE 100 may optionally include a trusted environment operably connected to the memory 140 by the public bus 101 or a private bus (not shown). The UE 100 may also include a communication interface 120 and a wireless transceiver 121 configured to send and receive wireless signals 123 via a wireless antenna 122 over a wireless communication network. The wireless transceiver 121 is connected to the bus 101. Here, the UE 100 is illustrated as having a single wireless transceiver 121. However, a UE 100 can alternatively have multiple wireless transceivers 121 and wireless antennas 122 to support multiple communication standards such as Wi-Fi, CDMA, Wideband CDMA (WCDMA), Long Term Evolution (LTE), BLUETOOTH short-range wireless communication technology, etc.

The communication interface 120 and/or wireless transceiver 121 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. A modulated signal may be transmitted on a different carrier and may carry pilot, overhead information, data, etc.

The UE 100 may also include a user interface 150 (e.g., display, GUI), and a Satellite Positioning System (SPS) receiver 155 that receives SPS signals 159 (e.g., from SPS satellites) via an SPS antenna 158. The SPS receiver 155 can communicate with a single global navigation satellite system (GNSS) or multiple such systems. A GNSS can include, but is not limited to, Global Positioning System (GPS), Galileo, Glonass, Beidou (Compass), etc. SPS satellites are also referred to as satellites, space vehicles (SVs), etc. The SPS receiver 155 measures the SPS signals 159 and may use the measurements of the SPS signals 159 to determine the location of the UE 100. The processor 111, memory 140, DSP 112 and/or specialized processor(s) (not shown) may also be utilized to process the SPS signals 159, in whole or in part, and/or to calculate the location of the UE 100, in conjunction with SPS receiver 155. Alternatively, UE 100 may support transfer of the SPS measurements to a location server (e.g. E-SMLC) that computes the UE location instead. Storage of information from the SPS signals 159 or other location signals is performed using a memory 140 or registers (not shown). While only one processor 111, one DSP 112 and one memory 140 are shown in FIG. 1, more than one of any, a pair, or all of these components could be used by the UE 100. The processor 111 and DSP 112 associated with the UE 100 are connected to the bus 101.

The memory 140 can include a non-transitory computer-readable storage medium (or media) that stores procedures as one or more instructions or code which are retrievable for execution by DSP(s) 112, general purpose processor(s) 111, or both. Media that can make up the memory 140 include, but are not limited to, RAM, ROM, FLASH, disc drives, etc. In general, the functions stored by the memory 140 are executed by general-purpose processor(s) 111, specialized processors, or DSP(s) 112. Thus, the memory 140 is a processor-readable memory and/or a computer-readable memory that stores software (programming code, instructions, etc.) configured to cause the processor(s) 111 and/or DSP(s) 112 to perform the procedures described. Alternatively, one or more functions of the UE 100 may be performed in whole or in part in hardware.

A UE 100 can estimate its current position within an associated system using various techniques, based on other communication entities within view and/or information available to the UE 100. For instance, a UE 100 may estimate its position using information obtained from access points (APs) associated with one or more wireless local area networks (WLANs), personal area networks (PANs) utilizing a short-range wireless communication technology such as BLUETOOTH or ZIGBEE®, etc., Global Navigation Satellite System (GNSS) or other Satellite Positioning System (SPS) satellites, and/or map constraint data obtained from a map server or LCI server. In some cases, a location server, which may be an E-SMLC, SLP or Standalone Serving Mobile Location Center (SAS), may provide assistance data to a UE 100 to enable or assist the UE 100 to make location related measurements (e.g., measurements of WLAN APs, cellular base stations, GNSS satellites). The UE 100 may then provide the measurements to the location server to compute a location estimate (which may be known as “UE assisted” positioning) or may compute a location estimate itself (which may be known as “UE based” positioning) based on the measurements and possibly based also on other assistance data provided by the location server (e.g., such as orbital and timing data for GNSS satellites or the precise location coordinates of WLAN APs and/or cellular base stations for use in OTDOA and AFLT processes).

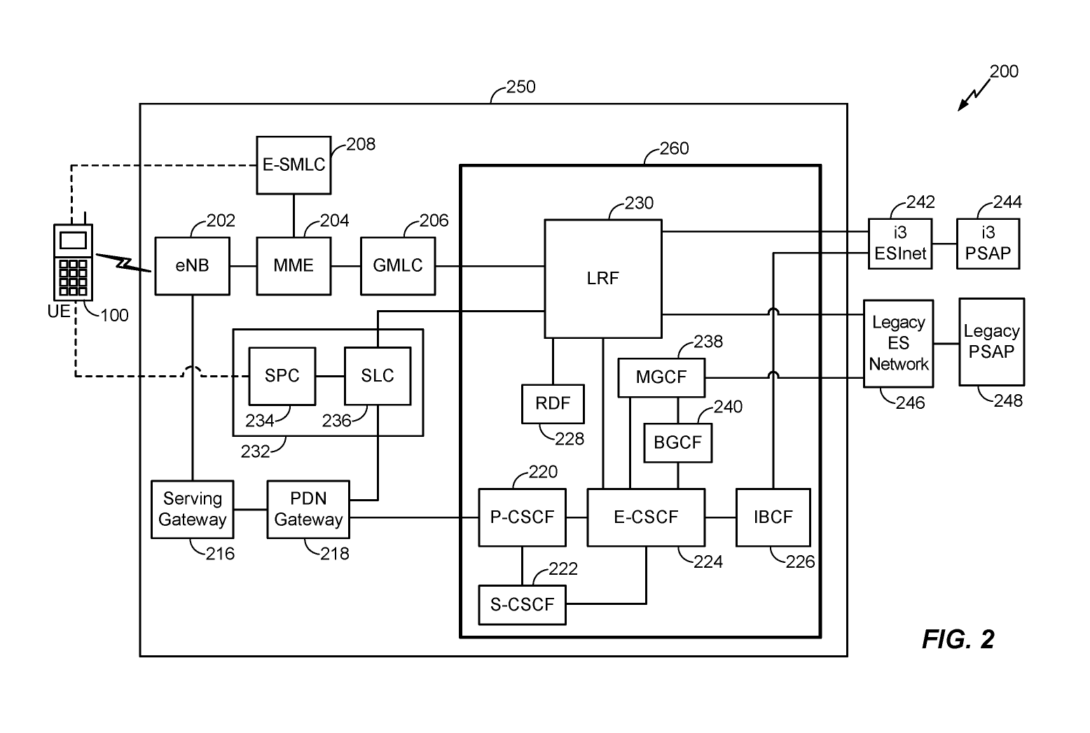

Referring to FIG. 2, with further reference to FIG. 1, an architecture 200 for supporting positioning of a UE 100 with 3GPP Long Term Evolution (LTE) access for a network 250 is shown. The network 250 may be an Evolved Packet System (EPS) that supports LTE access (e.g., by UE 100) and possibly other access types (not shown in FIG. 2) such as CDMA2000, Wideband CDMA (WCDMA) and/or WiFi. A UE 100 may communicate with a serving evolved Node B (eNodeB or eNB) 202 in a radio access network (RAN) to obtain communication services from the network 250. The RAN may include other network entities not shown in FIG. 2 for simplicity and may also be referred to as an Evolved Universal Terrestrial Radio Access Network (E-UTRAN). The eNB 202 may also be referred to as a Node B, a base station, an access point, etc. The UE 100 may (i) receive signals from eNB 202 and from other base stations (e.g. other eNBs) and APs in network 250; (ii) obtain the identities of the source eNBs and other base stations or of the source cells from the received signals and/or (iii) obtain measurements of the received signals such as measurements of time of arrival (TOA), RSTD for OTDOA positioning, pilot phase for AFLT positioning, and/or signal strength (e.g. received signal strength indication (RSSI)), signal quality (e.g. signal to noise ratio (S/N)), and/or signal round trip propagation time (RTT) for enhanced cell ID (ECID) positioning. The eNB, base station and/or cell identities and the different signal measurements may be used to derive a location estimate for UE 100 (e.g., by UE 100 or by a location server such as E-SMLC 208 or SLP 232). While only one eNB 202 is depicted in FIG. 2, the architecture 200 (e.g., network 250) may include multiple eNBs and/or other base stations and/or APs, each with one or more antenna systems such as used with Distributed Antenna Systems (DAS), Remote Radio Heads (RRHs), repeaters and relays.

The eNB 202 may communicate with a serving MME 204 for UE 100, which may perform various control functions such as mobility management, gateway selection, authentication, bearer management, etc. MME 204 may communicate with an Evolved Serving Mobile Location Center (E-SMLC) 208 and a Gateway Mobile Location Center (GMLC) 206. The E-SMLC 208 may support UE-based, UE-assisted, network-based and/or network-assisted positioning methods for UEs including UE 100 and may support one or more MMEs. E-SMLC 208 may support the 3GPP control plane location solution for LTE access as defined in 3GPP technical Specifications (TSs) 23.271 and 36.305. The E-SMLC 208 may also be referred to as a location server (LS), a Stand Alone SMLC (SAS), etc. The GMLC 206 may perform various functions to support location services and provide services such as subscriber privacy, authorization, authentication, billing, etc. A Location Routing Function (LRF) 230 may communicate with GMLC 206 and may route or help route IP-based emergency calls to a Public Safety Answering Points (PSAPs) such as the i3 ESInet 242 and i3 PSAP 244, and well as legacy systems such as the legacy ES network 246 and the legacy PSAP 248. LRF 230 may also support location requests from PSAPs (e.g., PSAPs 244 and 248) for UEs (e.g., UE 100) that are making emergency calls and may obtain locations for these UEs and return the locations to the requesting PSAPs. In order to support the routing and location functions that LRF 230 performs, LRF 230 may be configured to request the locations of different target UEs (e.g. UE 100) from a GMLC such as GMLC 206. In that case, GMLC 206 may transfer any location request for a target UE (e.g., UE 100) to an MME such as MME 204 which may transfer the request to an E-SMLC such as E-SMLC 208. The E-SMLC (e.g., E-SMLC 208) may then obtain location related measurements for the target UE from the serving eNB for the target UE and/or from the target UE, compute or verify any location estimate for the target UE and return the location estimate via the MME and GMLC (e.g., MME 204 and GMLC 206) to LRF 230. LRF 230 may also or instead be configured to request the locations of different target UEs (e.g., UE 100) from a SUPL Location Platform (SLP) such as SLP 232 described next. SLP 232 may include a SUPL Positioning Center (SPC) 234 and a SUPL Location Center (SLC) 236, and may be configured to communicate location information with the LRF 230 and support the SUPL user plane location solution defined by the Open Mobile Alliance (OMA) in order to obtain the locations of UEs such as UE 100. In order to support positioning of a UE such as UE 100, E-SMLC 208 and SLP 232 may each use the LTE Positioning Protocol (LPP) defined in 3GPP 36.355 and/or the LPP Extensions (LPPe) protocol defined by OMA in which LPP and/or LPPe messages are exchanged between E-SMLC 208 or SLP 232 and the target UE (e.g., UE 100) that is being positioned. In the case of E-SMLC 208, LPP and/or LPPe messages exchanged with a target UE may be transferred as signaling via the serving MME and serving eNB for the target UE (e.g., eNB 202 and MME 204 if the target UE is UE 100). In the case of SLP 232, LPP and/or LPPe messages exchanged with a target UE may be transferred as data using IP transport via a PDN Gateway, Serving Gateway and serving eNB for the target UE (e.g., PDN Gateway 218, Serving Gateway 216 both described next and eNB 202 if the target UE is UE 100).

A Serving Gateway 216 may perform various functions related to IP data transfer for UEs such as data routing and forwarding, mobility anchoring, etc. A Packet Data Network (PDN) Gateway 218 may perform various functions such as maintenance of data connectivity for UEs, IP address allocation, etc. An IP Multimedia Subsystem (IMS) 260 for network 250 may include various network entities to support IMS services such as Voice-over-IP (VoIP) calls and VoIP emergency calls. The IMS 260 may include a Proxy Call Session Control Function (P-CSCF) 220, a Serving Call Session Control Function (S-CSCF) 222, an Emergency Call Session Control Function (E-CSCF) 224, a Breakout Gateway Control Function 240, a Media Gateway Control Function (MGCF) 238, an Interconnection Border Control Function (IBCF) 226, a Routing Determination Function (RDF) 228 and the LRF 230.

In operation, the network 250 may utilize LTE interfaces and protocols for control plane location. The LPP protocol combined with the LPPe protocol may be used over the Uu interface between the UE 100 and the eNB 202 for positioning of the UE 100 by the E-SMLC 208. LPP/LPPe messages may be transferred (as previously described) between the UE 100 and the E-SMLC 208 via the MME 204 and the eNB 202 for the UE 100 as described in 3GPP TSs 23.271 and 36.305. The E-SMLC 208 may be configured to request (e.g., by sending an LPP/LPPe Request Location Information message to UE 100), and the UE 100 may be configured to provide (e.g., by sending an LPP/LPPe Provide Location Information message to E-SMLC 208) the signal measurements (e.g., RSSI, RTT, RSTD measurements) and identities of visible cells.

In an alternative embodiment, either (i) the LPP protocol alone without LPPe or (ii) the RRC protocol defined in 3GPP 36.331 may be used over the Uu interface between the UE 100 and the serving eNB 202 for positioning of the UE 100 by the E-SMLC 208. In the case of LPP (alternative (i)), LPP messages may be transferred between the UE 100 and the E-SMLC 208 via the MME 204 and the serving eNB 202 for the UE 100 as described in 3GPP TSs 23.271 and 36.305. In the case of RRC (alternative (ii)), RRC messages may be transferred between the UE 100 and the serving eNB 202 and LTE Positioning Protocol A (LPPa) messages (defined in 3GPP TS 36.455) may be transferred between eNB 202 and E-SMLC 208 via the MME 204 for the UE 100 as described in 3GPP TSs 23.271 and 36.305. In an example, the E-SMLC 208 may be configured to request (e.g., by sending an LPP Request Location Information message to UE 100 or an LPPa request message to eNB 202 which may cause eNB 202 to send an RRC request message to UE 100), and the UE 100 may be configured to provide (e.g., by sending an LPP Provide Location Information message to E-SMLC 208 or an RRC response to eNB 202 which causes eNB 202 to send an LPPa response to E-SMLC 208) the signal measurements (e.g., RSTD measurements) and identities of visible cells.

A Location Services (LCS) Application Protocol (LCS-AP) defined in 3GPP TS 29.171 may be used over an SLs interface between the MME 204 and the E-SMLC 208 to enable the MME 204 to request location information for the UE 100 from the E-SMLC 208 using the 3GPP control plane solution. An Evolved Packet Core (EPC) LCS Protocol (ELP) defined in 3GPP TS 29.172 may be used over an SLg interface between the MME 204 and the GMLC 206 to enable the GMLC 206 to request and obtain location information for the UE 100 using the 3GPP control plane solution.

The network 250 may also utilize interfaces and protocols for SUPL User Plane Location. A Lup interface as defined in OMA-AD-SUPL-V2_0 may be used between the UE 100 (referred to as a SUPL Enabled Terminal (SET)) and the SLP 232 to support positioning of the UE 100 using the OMA SUPL user plane solution. The Lup interface enables exchange of User Plane Location Protocol (ULP) messages, defined in OMA-TS-ULP-V2_0_3, between the UE 100 and the SLP 232. The SLP 232 may be a Home SLP (H-SLP) and reside in the home network of a UE (e.g., applicable to UE 100 if network 250 is the home network for UE 100) or may be a Discovered SLP (D-SLP) or Emergency SLP (E-SLP). A D-SLP may be used to position UE 100 in any network (e.g., applicable if network 250 is not the home network for UE 100) and an E-SLP may be used to position UE 100 if UE 100 is establishing or has established an emergency call (e.g., a VoIP emergency call via IMS 260 to i3 PSAP 244 or legacy PSAP 248). SLP 232 is split into the SLC 236 and the SPC 234 which may be separate logical functions of a single physical SLP 232 or separate physical entities. The SLC 236 is configured to establish and control a SUPL session with the UE 100. The SPC 234 is configured to obtain a location of the UE 100. The endpoint for any ULP message is then either the SLC 236 or the SPC 234 depending on whether the ULP message is used for control and service provision or for positioning. In the case of the UE 100 (e.g., with LTE access), the ULP messages used for positioning typically each encapsulate one or more LPP messages. Each encapsulated LPP message can further encapsulate one LPPe message, thereby enabling exchange of LPP and/or LPP/LPPe positioning protocol messages between UE 100 and SLP 232 as previously described. To support heightened accuracy location, LPP/LPPe may be used to enable the SPC 234 to request, and the UE 100 to return the same information (e.g., cell identities and RSTD measurements) as described for control plane location described above.

According to an embodiment, and as described in greater detail below, a mobile device (e.g., a UE) may receive one or more messages from a server comprising positioning assistance data for a downlink terrestrial positioning method. In addition, positioning assistance data may identify a plurality of cell transceivers and specify additional parameters descriptive of identified cell transceivers. The mobile device may then apply a particular processing to receive signals based, at least in part, on the additional parameters descriptive of the identified cell transceivers.

According to an embodiment, a UE may make multiple measurements involving radio sources—e.g. by using the cells associated with the radio sources a reference cell or neighbor cells for OTDOA. A location server can then receive OTDOA measurements from the UE that comprise measurements of reference signal time differences (RSTDs). As defined in 3GPP TS 36.214, an RSTD measurement is a measurement of a difference between the signal (e.g., PRS) time of arrival (TOA) from the reference cell at the UE and the TOA from any neighbor cell at the UE.

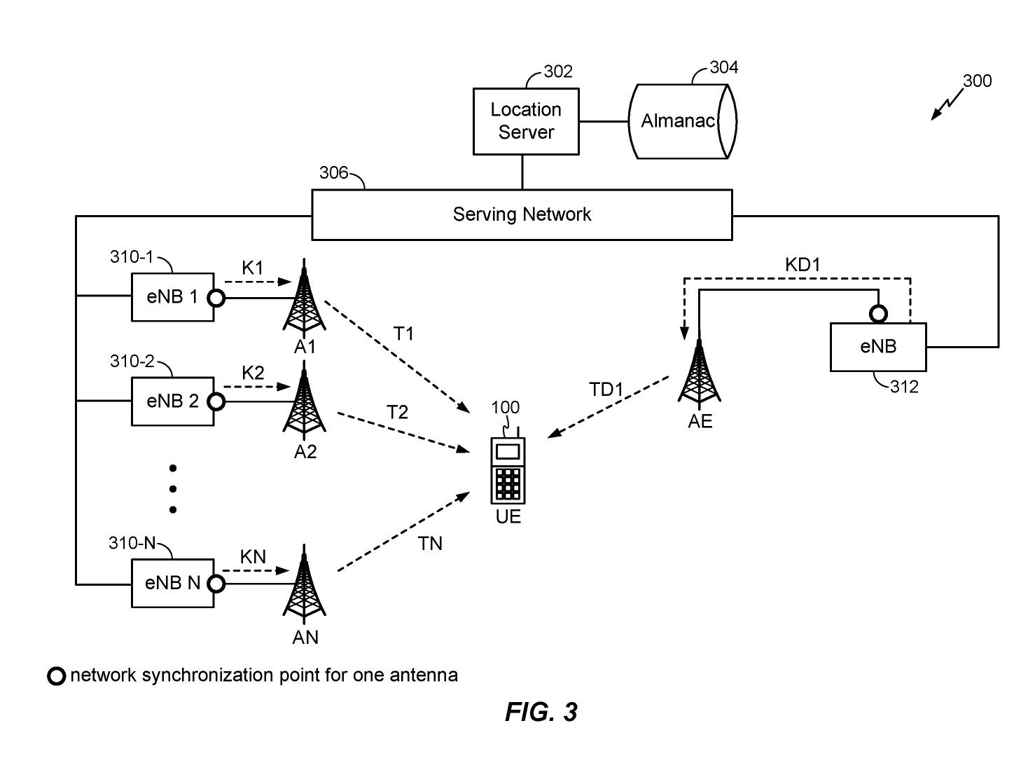

An example of the method is shown in FIG. 3 for a wireless communication system 300 employing LTE access and synchronized signal transmission (e.g. synchronized PRS transmission). The wireless communication system 300 includes a location server 302 and an almanac 304. The location server 302 and almanac 304 may be included as part of a serving network 306 or may be attached to or reachable from a serving network 306. For example, the serving network 306 may correspond to network 250 in FIG. 2, and the location server 302 may correspond to E-SMLC 208 or to SLP 232 in network 250 or may be another location server such as a Standalone Serving Mobile Location Center (SAS). The serving network 306 may include one or more access points such as eNB 1 310-1, eNB 2 310-2, eNB N, 310-N, and eNB 312. There may be other eNBs not explicitly shown in FIG. 3 such as eNBs n 310-n with n between 3 and N−1. Any one of the access points (e.g., eNB 312) may correspond to eNB 202 in FIG. 2. Each of the access points may be operably connected to one or more antennas. The antennas comprise A1, A2, . . . AN in the case of eNBs 310-1, 310-2 . . . 310-N, respectively, and AE in the case of eNB 312. An almanac 304 represents a database structure which may belong to serving network 306 and/or to location server 302 and may, in some embodiments, be part of location server 302 (e.g., contained in a storage medium in location server 302). Almanac 304 is configured to store identification and location parameters for the access points and base stations (e.g., eNBs) and antennas within the serving network 306 and may comprise a BSA of the type previously described here.

With synchronized signal transmission, the serving network 306 can employ a set of synchronization points (exemplified by the small circles in FIG. 3), one for each antenna A1, A2, . . . , AN and AE. Each synchronization point corresponds to a location along the signal transmission path for any signal transmitted by one antenna at which the signal timing is synchronized exactly or almost exactly to a common time (e.g., using GPS receivers) that is applicable to all the synchronization points. In the case of LTE, synchronization for each signal can align the start of each new set of 1024 LTE downlink system frames, the start of each 10.0 ms LTE radio frame or just the start of each new 1.0 ms LTE subframe to the same time (e.g. same global time) for each cell and for each radio antenna in each cell if a cell uses multiple radio antennas (e.g., DAS antenna elements or RRHs) to broadcast duplicates of the same signal. A synchronization point may correspond to signal transmission at an antenna or to signal propagation past some point prior to reaching the antenna such as a signal output jack from an eNB or an intermediate signal amplifier.

FIG. 3 shows N eNBs 310-1, 310-2, 310-N labelled 1 to N that each support a single cell using a single antenna labelled A1, A2 to AN. An eNB 312 also associated with a single cell is shown that uses an antenna AE. In particular implementations, an antenna A1 through AN may comprise a one or two port antenna, or a four port antenna. As referred to herein, an “antenna port” comprises an antenna element in combination with circuitry connected to one or more terminals of the antenna element to process radio frequency (RF) energy received at the antenna element and/or apply a power signal to one or more terminals of the antenna element to transmit RF energy away from the antenna element. As employed in particular implementations, an eNB may employ multiple antenna ports may be used for transmitting a downlink signal such that different individual antenna ports may be used to transmit different components of a downlink signal that is to be received at a UE. Here, an individual antenna port among multiple antenna ports used for transmitting a downlink signal comprises an antenna element and corresponding power circuitry to transmit a component of the downlink signal that is separate from antenna elements and corresponding power circuitry employed by other antenna ports for transmitting other components of the downlink signal. In an embodiment, multiple antenna ports used by a transmitter may enable independent control of transmission of corresponding multiple components of a downlink signal through a corresponding multiple of antenna elements.

In this context, a “one or two antenna port cell transceiver” or “cell transceiver transmitting a downlink signal using a one or two antenna port configuration” comprises a cell transceiver (e.g., an eNB) that employs no more than two antenna ports for transmission of a downlink signal. As such, a downlink signal transmitted by a one or two antenna port cell transceiver or a cell transceiver using a one or two antenna port configuration comprises no more than two individually components of a downlink signal. Similarly, a “four antenna port cell transceiver” or “cell transceiver transmitting a downlink signal using a four antenna port configuration” comprises four antenna elements and corresponding circuitry to transmit a corresponding four individually controllable components of a downlink signal to be received at a UE. In one example implementation, a parameter “antennaPortConfig” defined in OTDOA Assistance Data Elements as set forth in 3GPP 36.355 CH 6.5.1.2 may indicate a particular cell transceiver has having a one or two-antenna port configuration, or a four antenna port configuration.

In particular implementations as discussed below, UE 100 may receive messages from location server 302 comprising assistance data including, for example, identifiers for a plurality of cell transceivers (e.g., including eNB-1, eNB-2, . . . , eNB-N and eNB 312). Furthermore, for one or more of the identified cell transceivers, the positioning assistance data may further specify attributes of cell transceivers including, for example, whether the cell transceivers are transmitting a downlink signal having PRS using a one or two port antenna configuration, or transmitting a downlink signal having a PRS in a four port antenna configuration. UE 100 may then determine how to process a PRS in a particular downlink signal.

It should be noted that while the techniques as described above may be applied by a location server 302, the techniques can also be used at a UE 100 to calculate its location if a location server 302 and/or other network entity (e.g. a base station) provides the UE 100 with the information to enable performing a location computation such as the location coordinates of the neighbor eNBs (e.g., in the form of assistance data such as BSA).

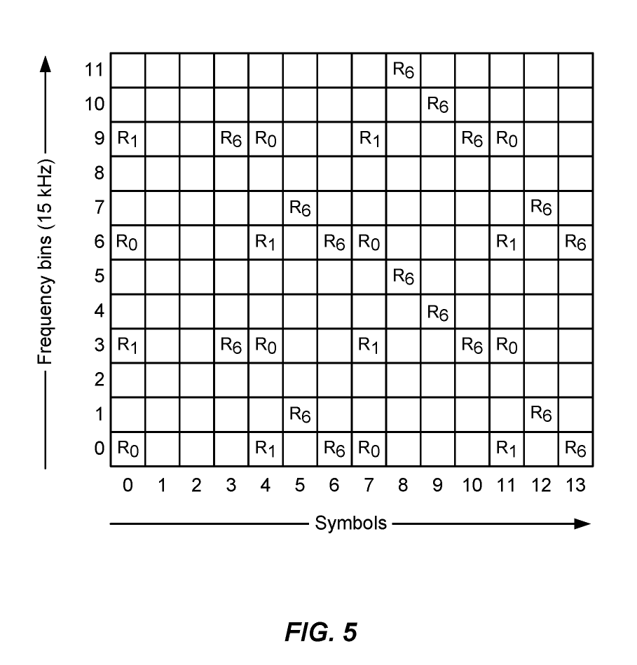

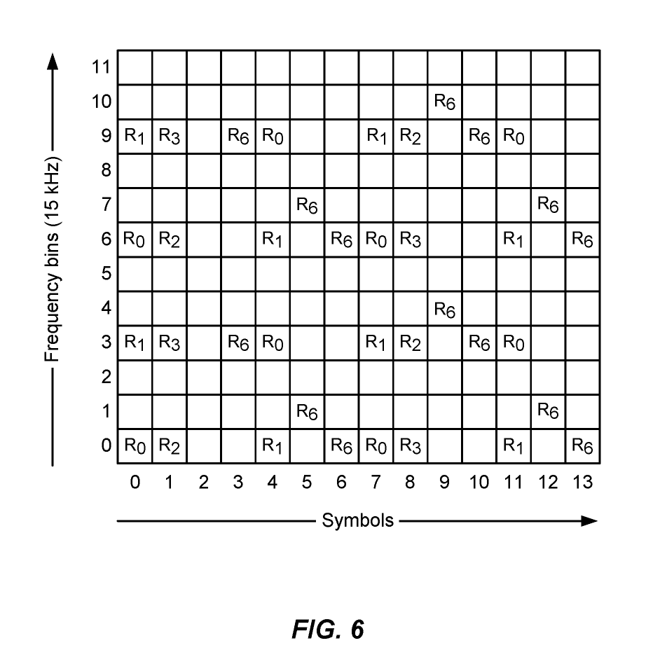

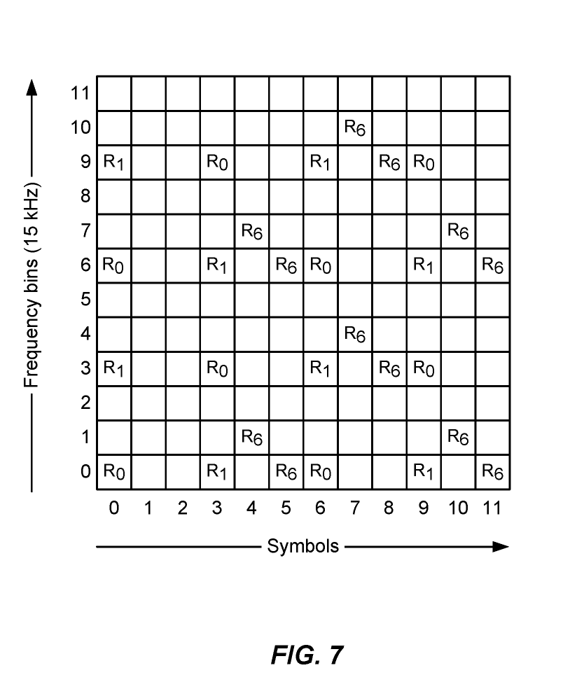

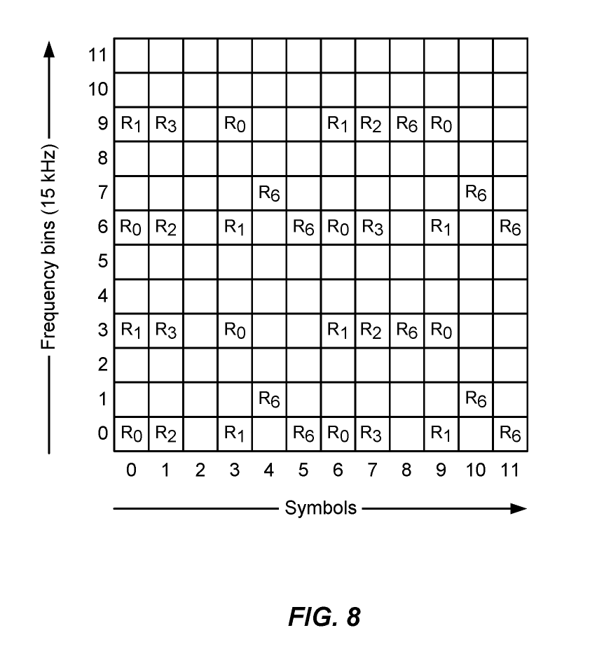

According to an embodiment, eNBs 310 may transmit a downlink signal using a one or two port antenna configuration, or a four port antenna configuration. A PRS in a downlink signal transmitted by an eNB 310 using a one or two port antenna configuration may have one particular symbol encoding while a PRS in a downlink signal transmitted by an eNB 310 using a four antenna port configuration may have a different symbol encoding. For example, as shown in the symbol encoding of a downlink signal shown in FIGS. 5 and 6, for normal cyclic pre-fix (NCP), symbol #8 is assigned to a PRS transmitted by an eNB using a one or two antenna port configuration while symbol #8 is assigned to a CRS for a downlink transmitted by an eNB using a four antenna port configuration. Similarly, as shown in the symbol encoding of a downlink signal shown in FIGS. 7 and 8, for extended cyclic pre-fix (ECP) symbol #7 is assigned to a portion of a PRS in a first downlink signal transmitted by a first eNB using a one or two antenna port configuration while symbol #7 is assigned to a portion of a CRS or a second downlink signal transmitted by a second eNB using a four antenna port configuration.

Under certain conditions, a portion of a first downlink signal transmitted by a first eNB 310 using a four antenna port configuration may jam or interfere at UE 100 with at least a portion of a PRS (e.g., symbol #7 for a PRS with an NCP or symbol #8 for an PRS) in a second downlink signal transmitted by a second eNB 310 using a one or two antenna port configuration. Additionally, in certain implementations, system 300 may deploy a mixture of eNBs 310 having one or two antenna port configurations for transmitting a downlink signal with eNBs 310 having four antenna port configurations for transmitting a downlink signal.

In certain scenarios, collisions of symbol #8 in a downlink transmitted using a four antenna port configuration with a portion of a PRS in symbol #8 of a downlink signal transmitted using a one or two antenna port configuration may limit a useable dynamic range for the PRS transmitted using a one or two antenna port configuration to 23.5 dB for 20 MHz PRS_BW. In addition, a sensitivity loss of blanking symbol #8 for a PRS transmitted using a one or two antenna port configuration has been simulated to be ˜0.5 dB. Blanking of symbol #8 in this particular case may be equivalent to treating the cell as a four antenna port cell. As discussed below in particular implementations, to address interference/jamming processing of a PRS transmitted by an eNB 310 using a one or two antenna port configuration at UE 100 may be affected or altered in the presence of one or more downlink signals transmitted by an eNB 310 using a four antenna port configuration.

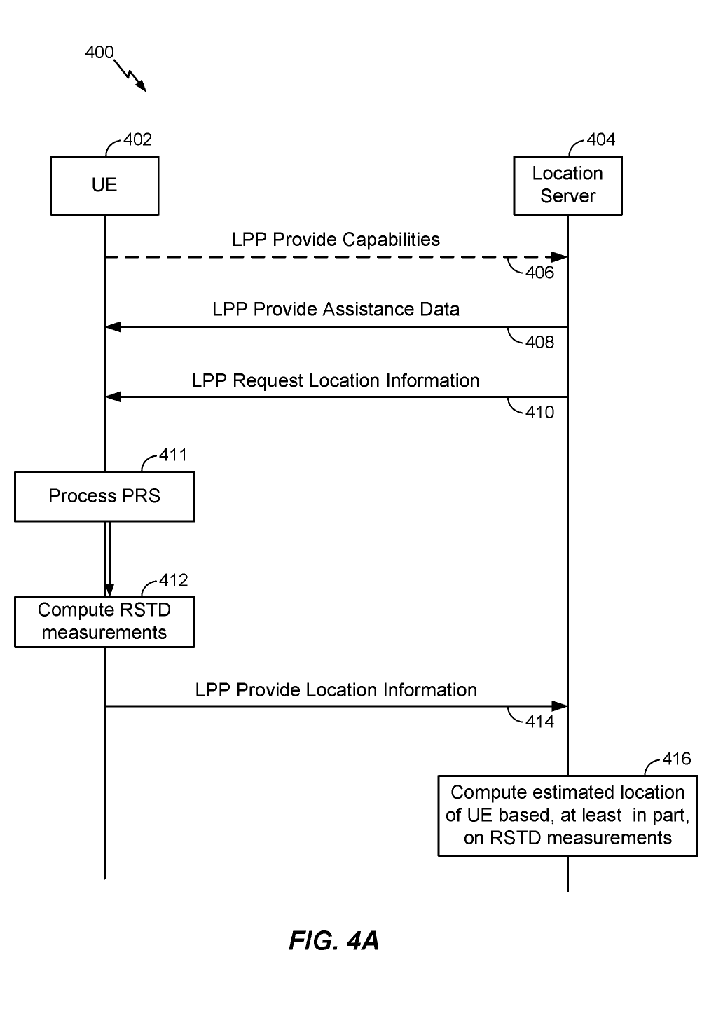

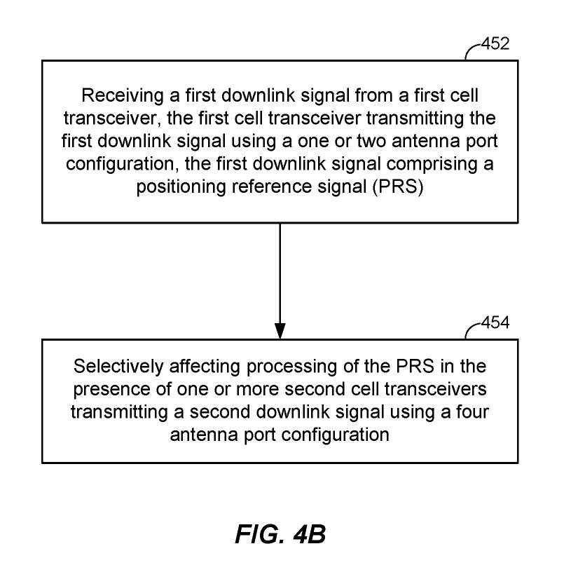

Referring to FIG. 4A, with further reference to FIGS. 1-3, a message flow diagram 400 of an example procedure for supporting positioning using the LPP protocol is shown. The entities in the message flow include a UE 402 and a location server 404. UE 402 may correspond to UE 100 in FIGS. 1-3 and location server 404 may correspond to the E-SMLC 208 or SLP 232 in FIG. 2 and/or to the location server 302 in FIG. 3. Positioning of UE 402 as exemplified in FIG. 4A is supported via an exchange of LPP messages between the UE 402 and the location server 404. The LPP messages and the procedures that they support are described in 3GPP TS 36.355. The procedure shown in FIG. 4A may be used to estimate a location of the UE in order to support some location related service like navigation or direction finding support for UE 402 (or for the user of UE 402) or for routing or provision of a dispatchable location to a PSAP in association with an emergency call from UE 402 to a PSAP, or for some other reason. Initially and as an optional step, the UE 402 may provide its positioning capabilities to the location server 404 relative to the LPP protocol by sending an LPP Provide Capabilities message 406 to location server 404 indicating the position methods and features of these position methods that are supported by UE 402 using LPP. Location server 404 may then determine to position the UE 402 using OTDOA for LTE access—e.g. because the UE 402 capabilities sent in message 406 indicate support of OTDOA by UE 402 and/or because UE 402 may currently have LTE wireless access to a serving network containing location server 404. Location server 404 may then send an LPP Provide Assistance Data message 408 to UE 402. The LPP Provide Assistance Data message 408 may include OTDOA assistance data to enable UE 402 to make and return OTDOA RSTD measurements and may include information for a reference cell that may include a global ID for the reference cell, a physical cell ID for the reference cell, frequency information, PRS signal information (e.g., bandwidth, number of subframes per PRS positioning occasion, starting point and periodicity of PRS positioning occasions, muting sequence). The LPP Provide Assistance Data message 408 may also include OTDOA assistance data for neighboring cells. In an example, if the UE 402 indicates support for inter-frequency RSTD measurements, the neighbor cell assistance data may be provided for up to three frequency layers. The information provided for each neighbor cell in message 408 may be similar to that provided for the reference cell (e.g., may include a cell ID, cell frequency and PRS signal information).

In a particular implementation, LPP Provide Assistance Data message 408 may comprise positioning assistance data including, for example, identifiers of a plurality of cell transceivers and other parameters descriptive of attributes of cell transceivers. For example, LPP Provide Assistance Data message 408 may indicate which of the identified cell transceivers are transmitting a PRS in a downlink signal using one or two antenna ports, and indicate which of the identified cell transceivers are transmitting a downlink signal using four antenna ports. As discussed below, positioning assistance data in LPP Provide Assistance Data message 408 may enable UE 402 to alter or affect processing of a PRS in a first downlink signal transmitted using one or two antenna ports in the presence of a second downlink signal transmitted using four antenna ports.

The location server 404 may send an LPP Request Location Information message 410 to UE 402 to request OTDOA RSTD measurements for the reference cell and neighbor cells indicated in the message 408. The LPP Request Location Information message 410 may include environmental characterization data to provide the UE 402 with information about expected multipath and non-line of sight (LOS) in the current area. The LPP Request Location Information message 410 may also include a desired accuracy (e.g., of a location estimate based on RSTD measurements provided by the UE) and a response time (e.g., the maximum time between receipt of the LPP Request Location Information message 410 by the UE 402, and the time of the transmission of an LPP Provide Location Information message 414 by the UE 402). An optional periodic reporting period may also be included in the message.

As pointed out above, positioning assistance data received at message 408 may provide an indication as to which local cells may or may not be used as a reference cell for OTDOA positioning. Alternatively, UE 402 may select a reference cell for an ODTOA session from among multiple cells identified in assistance data received at message 408. In one example, UE 402 may select a serving cell as a reference cell. In other embodiments, UE 402 may apply additional rules or heuristics to select a reference cell from among multiple identified cells.

At stage 411, PRS' transmitted from multiple cell transceivers may be processed to detect times of arrival, for example. As pointed out above, UE 402 may operate in an environment where some cell transceivers are transmitting a downlink signal with a PRS using a one or two antenna port configuration while other cell transceivers are transmitting a downlink using a four antenna port configuration. Here, UE 402 may selectively affect processing of a PRS in a first downlink signal transmitted by a cell transceiver using one or two antenna port configuration in the presence of one or more second cell transceivers transmitting a downlink signal using a four antenna port configuration.

At stage 412, the UE 402 utilizes the OTDOA positioning assistance data received in message 408 and any additional data (e.g. desired QoS) received in the message 410 to perform RSTD measurements for the OTDOA position method. The RSTD measurements may be made between the reference cell and each of the neighbor cells indicated in the message 408. Alternatively, the UE 402 may choose a different reference cell (e.g., if strong signals are not received from the reference cell indicated in message 408 or if this reference cell is not the current serving cell for UE 402). The UE 402 then sends an LPP Provide Location Information message 414 to the location server 404 after some or all of the requested RSTD measurements have been obtained at stage 412 and before or when a maximum response has expired (e.g., a maximum response time provided by the location server 404 in message 410). The LPP Provide Location Information message 414 may include the time at which the RSTD measurements were obtained and the identity of the reference cell for the RSTD measurements. The message 414 may also include a neighbor cell measurement list including, for each measured neighbor cell, the identity of the cell (e.g. physical cell ID, global cell ID and/or cell carrier frequency), the RSTD measurement for the cell and the quality of the RSTD measurement for the cell. The neighbor cell measurement list may include RSTD data for one or more cells.

FIG. 4B is a flow diagram of actions that may be performed by UE 402 in processing a PRS in a received downlink signal according to a particular implementation of block 411. At block 452, a mobile device may receive a downlink signal comprising a PRS transmitted from a first cell transceiver using a one or two antenna port configuration. As pointed out above, being transmitted in a downlink signal from a one or two antenna port configuration, the PRS transmitted in the first downlink may have a particular encoding or symbol mapping in frequency bins as shown in FIG. 5 with normal cyclic pre-fix (NCP), or as shown in FIG. 7 with extended cyclic pre-fix (ECP).

Also as discussed above, a mobile device may receive the first downlink signal at block 452 in the presence of a second downlink signal transmitted by a second cell transceiver using a four antenna port configuration. The second downlink signal may have a particular encoding or symbol mapping of an NCP PRS and CRS in frequency bins as shown FIG. 6, or a particular encoding or symbol mapping of an ECP PRS and CRS in frequency bins as shown in FIG. 8. Also as discussed above, a CRS transmitted at least in part as symbol #8 in a downlink signal transmitted by a second cell transceiver using a four antenna port configuration may, at a receiver, interfere with or jam a symbol #8 of an NCP PRS transmitted by a first cell transceiver using a one or two antenna port configuration. Similarly, a CRS transmitted at least in part as symbol #7 in a downlink signal transmitted by a second cell transceiver using a four antenna port configuration may, at a receiver, interfere with or jam a symbol #7 of an ECP PRS transmitted by a first cell transceiver using a one or two antenna port configuration.

At block 454, a mobile device may selectively affect processing of the first PRS in the first downlink signal received at block 452 in the presence of one or more second cell transceivers transmitting a second downlink signal using a four antenna port configuration. In this context, “selectively affecting processing” means changing processing of a signal at a receiver to provide a processing result in at least one aspect under certain conditions. In one example implementation, a mobile device may affect processing of the first PRS by apply a processing to the first PRS (in the first downlink signal transmitted using a one or two antenna port configuration) as if the first PRS is in a downlink signal transmitted using four antenna ports. For example, if the first PRS comprises an NCP PRS, the mobile station may blank or ignore, or otherwise not process, symbol #8 in the first PRS as this symbol may be jammed or corrupted by an interfering CRS in symbol #8 in a downlink signal transmitted using a four antenna port configuration. Similarly, if the first PRS comprises an ECP PRS, the mobile device may blank or ignore, or otherwise not process, symbol #7 in the first PRS as this symbol may be jammed or corrupted by CRS in symbol #7 of a downlink signal transmitted using four antenna ports. In on embodiment, if a cell transceiver were to be considered as having a four antenna port configuration, then the symbol #7 in the first PRS symbol in question may be ignored in the PRS processing. Thus, flagging the particular cell transceiver as having a four-port configuration instead of 1-or-2 port configuration before processing may achieve a goal of ignoring the potentially interfering symbol. However, it is pointed out that if the particular cell transceiver in question is delayed or advanced by a significant portion of one symbol, the symbol may have some overlap with other potentially interfering symbols. In such cases, a blanking-mask corresponding to the potentially detrimental symbols may be applied before processing.

In an alternative embodiment, a mobile device at block 454 may affect processing of the first PRS signal by processing the first PRS using two different methods providing two different results, and then selecting one of the two different results (e.g., for obtaining an RSTD measurement). For example, a mobile device may obtain a first measurement by applying a first processing method to a PRS in a received downlink signal as if the downlink signal is transmitted using a four antenna port configuration (e.g., blanking or ignoring, or otherwise not processing, symbol #7 for PRS with ECP or #8 for PRS with NCP). The mobile device may also obtain a second measurement by applying a second processing method to the PRS in the received downlink signal as if the downlink signal is transmitted using a one or two antenna port configuration. The mobile device may then compare characteristics, such as SNR, of the first and second measurements to determine whether the received PRS is to be continued to be processed as if the received PRS is transmitted using four antenna port configuration or to be continued to be processed as if the received PRS is transmitted using a one or two antenna port configuration. In another particular embodiment, a mobile device may selectively affect processing of a PRS in a first downlink signal transmitted using one or two antenna ports in the presence of a second downlink signal further comprises cancelling at least a portion of a CRS portion of the second downlink signal interfering with the PRS signal at the mobile device.

In this context, a “presence of one or more second cell transceivers transmitting a second downlink signal” means that the second downlink is being received at the mobile device with sufficient power to be detectable, or to interfere with or jam at least a portion of another signal received at the mobile device from at least one other source. According to an embodiment, block 454 may determine whether one or more second cell transceivers is present and transmitting a second downlink signal using a four antenna port configuration based, at least in part, on a neighbor list (e.g., provided in positioning assistance data in LPP Provide Assistance Data message 408). In an example, a neighbor list in LPP Provide Assistance Data message 408 may identify which particular cell transceivers are transmitting a downlink signal using a one or two antenna port configuration and which particular cell transceivers are transmitting a downlink signal using a four antenna port configuration.

In particular implementations, block 454 may not in all scenarios necessarily affect processing of the PRS in the first downlink signal the presence of one or more second cell transceivers transmitting a second downlink signal. For example, block 454 may apply additional criteria in the presence of a second cell transceiver transmitting a second downlink signal using a four antenna port configuration to determine whether the processing of the PRS in the first downlink signal is to be selectively affected as discussed above. In an implementation, block 454 may further determine whether at least a portion of a second downlink signal (transmitted by a cell transceiver using a four antenna port configuration) is likely to jam or interfere with a PRS transmitted in a downlink signal using a one or two antenna port configuration. As may be observed, the maps of FIGS. 5 through 8 show an allocation of symbols at symbol positions #0 through #11 for each frequency bin of frequency bins numbered #0 through #11. Thus, each frequency bin in a map may have a particular allocation of symbols at each symbol position #0 through #11. For example, NCP PRS for a particular cell transceiver as shown in FIG. 5 shows frequency bin #9 being allocated symbol R₀ at symbol positions #4 and #11, symbol R₁ at symbol positions #0 and #7, symbol R₆ at symbol positions #3 and #10, and no symbol allocated to any other symbol position. Frequency bin #8 shows that no symbols are allocated to symbol positions #0-11. According to an embodiment, a particular allocation of symbols to frequency bins for a PRS transmitted by a particular cell transceiver may be based, at least in part, on a PCI assigned to the cell transceiver as set forth in 3GPP 36.211 at Chapter 6.10. For example, a different cell transceiver having an assigned PCI different from the PCI of the cell transceiver of NCP PRS of FIG. 5, the PRS transmitted by the different cell transceiver may have symbol allocations “shifted” or “rotated” by frequency bins. For example, a symbol allocation for the PRS transmitted by the different cell transceiver may be shifted from the allocation of FIG. 5 by one frequency bin such that frequency bin #10 (having “shifted” symbol allocation of frequency bin #9 shown in FIG. 5) is allocated symbol R₀ at symbol positions #4 and #11, symbol R₁ at symbol positions #0 and #7, symbol R₆ at symbol positions #3 and #10, and no symbol allocated to any other symbol position. Similarly, a symbol allocation for the PRS transmitted by the different cell transceiver may be shifted from the allocation of FIG. 5 by one frequency bin such that frequency bin #9 (having “shifted” symbol allocation of frequency bin #8 shown in FIG. 5) is allocated no symbols in symbol positions #0-11. Symbol allocations at frequency bins #0-7 and 10 of the mapping shown in FIG. 5 may be similarly “shifted” by one frequency bine to frequency bins #1-8 and 11, respectively. A symbol allocation at frequency bin #11 of the mapping shown in FIG. 5 may be “rotated” to frequency bin #0. Thus, in an embodiment, block 454 may further determine whether to affect processing of the first downlink signal a second cell transceiver transmitting a second downlink signal using a four antenna port configuration based, at least in part, on a PCI associated with the second cell transceiver.

In one particular example where a PRS with a Normal Cyclic Prefix in a first downlink signal is transmitted by a first cell transceiver using a one or two antenna port configuration, a mobile device at block 454 may further determine whether a second downlink signal transmitted by a neighboring cell transceiver using a four antenna port configuration is likely to interfere with reception of the PRS based, at least in part, on PCIs assigned to the neighboring cell transceivers. For example, a difference between PCIs may indicate an extent to which symbol allocations among frequency bins in mappings of PRS' transmitted by the neighboring cell transceivers have been “rotated” or “shifted” relative to one another. Consider FIGS. 5 and 6 for NCP 1-or-2-port and NCP 4-port antenna configurations. Symbol position #8 of the mapping of FIG. 5 shows that a cell may transmit PRS in frequency bins #5 and #11. The PRS mapping of FIG. 6 shows transmission of a CRS at symbol position #8 in frequency bins #0, #3, #6 and #9. Thus, CRS in mapping of a 4-port cell transceiver as shown in FIG. 6 (e.g., with a particular rotation or shift of symbol allocations of zero) would not collide in symbol #8 with PRS of a 1-or-2-port cell also with modulo shown in FIG. 5. However, a PRS mapping in symbol #8 of a 1-or-2-port cell shown in FIG. 5 would collide with CRS in symbol #8 of a 4-port cell having a mapping shown in FIG. 6 with symbol allocations but “rotated” or “shifted” by two or five frequency bins as reflected in a difference in PCIs assigned to the neighboring cell transceivers.

In another particular example where a PRS is transmitted a first downlink signal with an Extended Cyclic Prefix by a first cell transceiver using a one or two antenna port configuration, a mobile device may further determine whether a second downlink signal transmitted by a neighboring cell transceiver using a four antenna port configuration is likely to interfere with reception of the PRS at the mobile device further by determining whether the neighboring cell transceiver has a PCI-mod3 difference of −2 or +1 with respect to the first cell transceiver. Consider, for example, that neighboring cell transceivers transmit according to the PRS mappings for ECP 1-or-2-port antenna configuration shown in FIG. 7 and ECP 4-port antenna configuration shown in FIG. 8. Symbol #7 position of the mapping of FIG. 7 indicates transmission of PRS in frequency bins #4 and #11. Symbol position #7 of the mapping of FIG. 8 indicates transmission of a CRS in frequency bins #0, #3, #6 and #9. Thus, transmission CRS of a 4-port cell transceiver according to a mapping shown in FIG. 8 with no rotation or shifting of symbol allocations among frequency bins would not collide with a PRS symbol at symbol position #7 of a 1-or-2-port cell transceiver according to a mapping shown in FIG. 7. However, PRS in symbol #7 of a 1-or-2-port cell as shown in FIG. 7 would collide with a CRS in symbol #8 of a 4-port cell transceiver according to a mapping shown in FIG. 8 but with a symbol allocation shifted by one or four frequency bins as reflected in a difference between PCIs for the neighboring cell transceivers.

In another implementation, to further determine whether processing of a PRS in a first downlink signal transmitted by one or two antenna ports of a cell transceiver should be affected or altered, block 454 may determine a first signal strength of the first downlink signal (transmitted using a one or two antenna port) and second signal strength of any second downlink signal (transmitted using four antenna ports by a different cell transceiver) using direct measurement at the mobile device. If the second signal strength is sufficiently high in comparison to the first signal strength, UE may apply processing to the first PRS as if the first PRS is transmitted using four antenna ports as discussed above.

In another embodiment, to further determine whether processing of a first PRS in a first downlink signal transmitted by one or two antenna ports of a cell transceiver should be affected or altered, block 454 may process a PRS received from multiple cell transceivers as if the PRS is transmitted in a downlink signal using a one or two antenna port configuration in a first computation, and as if the PRS is transmitted in a downlink signal using a four antenna port configuration in a second computation. A result of either the first computation or the second computation may be selected for obtaining an RTSD measurement based on whether the first or second computation provides the best characteristics (e.g., highest SNR).

In another embodiment, location server 404 may perform an a-priori analysis of positioning assistance data and/or other factors discussed above in connection with block 454 to determine which PRS' (transmitted from cell transceivers identified as transmitting a downlink signal using a one or two antenna port configuration) are to be processed by UE 402 as being transmitted by a one or two antenna port cell transceiver and which PRS' are to be processed by UE 402 as being transmitted by a four antenna port cell transceiver. LPP Provide Assistance Data message 408 may then provide indications to UE 402 as to which PRS' are to be processed as being transmitted by a one or two antenna port cell transceiver, and which PRS' are to be processed as being transmitted by a four antenna port cell transceiver. In a particular implementation, LPP Provide Assistance Data message 408 may identify particular neighboring cell transceivers transmitting a downlink signal using a four antenna port configuration, and then provide an additional identifier to indicate whether processing of a PRS in a downlink signal transmitted from a one or two antenna port configuration is to be altered as discussed above.

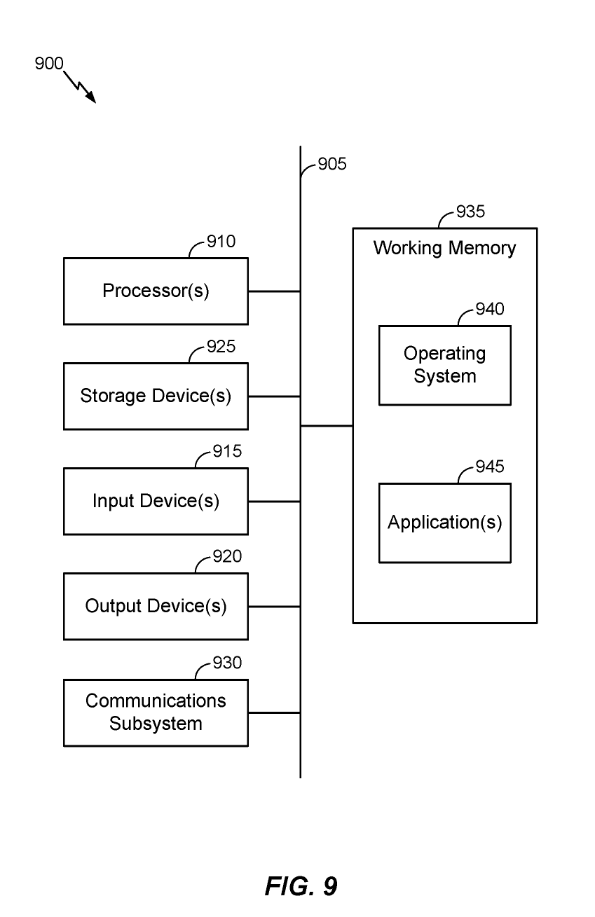

Referring to FIG. 9, with further reference to FIGS. 1-8, a computer system 900 may be utilized in to at least partially implement the functionality of some of the elements in FIGS. 4A and 4B. FIG. 9 provides a schematic illustration of one embodiment of a computer system 900 that can perform the methods provided by various other embodiments, as described herein, and/or can function as a mobile device or other computer system. For example, the location server 302, location server 404 and the almanac 304 may be comprised of one or more computer systems 900. FIG. 9 provides a generalized illustration of various components, any or all of which may be utilized as appropriate. FIG. 9 therefore, broadly illustrates how individual system elements may be implemented in a relatively separated or relatively more integrated manner.

The computer system 900 is shown comprising hardware elements that can be electrically coupled via a bus 905 (or may otherwise be in communication, as appropriate). The hardware elements may include one or more processors 910, including without limitation one or more general-purpose processors and/or one or more special-purpose processors (such as digital signal processing chips, graphics acceleration processors, and/or the like); one or more input devices 915, which can include without limitation a mouse, a keyboard and/or the like; and one or more output devices 920, which can include without limitation a display device, a printer and/or the like. The processor(s) 910 can include, for example, intelligent hardware devices, e.g., a central processing unit (CPU) such as those made by Intel® Corporation or AMD®, a microcontroller, an ASIC, etc. Other processor types could also be utilized.

The computer system 900 may further include (and/or be in communication with) one or more non-transitory storage devices 925, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 900 might also include a communications subsystem 930, which can include without limitation a modem, a network card (wireless or wired), an infrared communication device, a wireless communication device and/or chipset (such as a Bluetooth short-range wireless communication technology transceiver/device, an 802.11 device, a WiFi device, a WiMax device, cellular communication facilities, etc.), and/or the like. The communications subsystem 930 may permit data to be exchanged with a network (such as the network described below, to name one example), other computer systems, and/or any other devices described herein. In many embodiments, the computer system 900 will further comprise, as here, a working memory 935, which can include a RAM or ROM device, as described above.

The computer system 900 also can comprise software elements, shown as being currently located within the working memory 935, including an operating system 940, device drivers, executable libraries, and/or other code, such as one or more application programs 945, which may comprise computer programs provided by various embodiments, and/or may be designed to implement methods, and/or configure systems, provided by other embodiments, as described herein. Merely by way of example, one or more processes described herein might be implemented as code and/or instructions executable by a computer (and/or a processor within a computer). Such code and/or instructions can be used to configure and/or adapt a general purpose computer (or other device) to perform one or more operations in accordance with the described methods.

A set of these instructions and/or code might be stored on a computer-readable storage medium, such as the storage device(s) 925 described above. In some cases, the storage medium might be incorporated within a computer system, such as the computer system 900. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 900 and/or might take the form of source and/or installable code, which, upon compilation and/or installation on the computer system 900 (e.g., using any of a variety of generally available compilers, installation programs, compression/decompression utilities, etc.) then takes the form of executable code.

Substantial variations may be made in accordance with specific desires. For example, customized hardware might also be used, and/or particular elements might be implemented in hardware, software (including portable software, such as applets, etc.), or both. Further, connection to other computing devices such as network input/output devices may be employed.

The computer system 900 may be used to perform methods in accordance with the disclosure. Some or all of the procedures of such methods may be performed by the computer system 900 in response to processor 910 executing one or more sequences of one or more instructions (which might be incorporated into the operating system 940 and/or other code, such as an application programs 945) contained in the working memory 935. Such instructions may be read into the working memory 935 from another computer-readable medium, such as one or more of the storage device(s) 925. Merely by way of example, execution of the sequences of instructions contained in the working memory 935 might cause the processor(s) 910 to perform one or more procedures of the methods described herein.

The terms “machine-readable medium” and “computer-readable medium,” as used herein, refer to any medium that participates in providing data that causes a machine to operate in a specific fashion. In an embodiment implemented using the UE 100 and/or the computer system 900, various computer-readable media might be involved in providing instructions/code to processor(s) 111, 910 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 140, 925. Volatile media include, without limitation, dynamic memory, such as the working memory 140, 935. Transmission media include, without limitation, coaxial cables, copper wire and fiber optics, including the wires that comprise the bus 101, 905, as well as the various components of the communications subsystem 930 (and/or the media by which the communications subsystem 930 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, a Blu-Ray disc, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 111, 910 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the UE 100 and/or computer system 900. These signals, which might be in the form of electromagnetic signals, acoustic signals, optical signals and/or the like, are all examples of carrier waves on which instructions can be encoded, in accordance with various embodiments of the invention.

The methods, systems, and devices discussed above are examples. Various alternative configurations may omit, substitute, or add various procedures or components as appropriate. For instance, in alternative methods, stages may be performed in orders different from the discussion above, and various stages may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein, the term “mobile device” refers to a device that may from time to time have a position location that changes. The changes in position location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, characteristics, terms, numbers, numerals, messages, frames, estimates, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. In this context, a “wireless communication network” comprises multiple devices or nodes capable of communicating with one another through one or more wireless communication links. As shown in FIG. 2, for example, a wireless communication network may comprise two or more devices. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, or if used to associate a list, such as A, B or C, is intended to mean A, B, and C, here used in the inclusive sense, as well as A, B or C, here used in the exclusive sense. In addition, the term one or more and/or similar terms is used to describe any feature, structure, and/or characteristic in the singular and/or is also used to describe a plurality and/or some other combination of features, structures and/or characteristics. Likewise, the term “based on,” “based, at least in part, on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method at a user equipment comprising:
receiving a first downlink signal from a first cell transceiver, the first cell transceiver transmitting the first downlink signal using a one or two antenna port configuration, the first downlink signal comprising a positioning reference signal (PRS); and
selectively affecting processing of the PRS of the first downlink signal in a presence of one or more second cell transceivers transmitting a second downlink signal using a four antenna port configuration.

2. The method of claim 1, wherein the second downlink signal comprises a cell-specific reference signal (CRS) with at least one symbol interfering with at least one symbol of the PRS of the first downlink signal.

3. The method of claim 1, wherein selectively affecting processing of the PRS of the first downlink signal comprises applying a processing to the PRS of the first downlink signal as if the PRS of the first downlink signal is transmitted using the four antenna port configuration.

4. The method of claim 3, wherein applying the processing to the PRS of the first downlink signal as if the PRS of the first downlink signal is transmitted using the four antenna port configuration further comprises ignoring, blanking or not processing at least one symbol in the PRS of the first downlink signal that is not included in a PRS transmitted using the four antenna port configuration.

5. The method of claim 1, and further comprising:
determining a first received signal strength, wherein the first received signal strength is determined from the first downlink signal; and
determining a second received signal strength, wherein the second received signal strength is determined from signals received from the one or more second cell transceivers; and
selectively applying the processing to the PRS of the first downlink signal as if the PRS of the first downlink signal is transmitted in a downlink signal using the four antenna port configuration based, at least in part, on a comparison of the first received signal strength and the second received signal strength.

6. The method of claim 5, wherein the comparison comprises determining whether a difference between the first received signal strength and the second received signal strength exceeds a threshold value.

7. A user equipment (UE) comprising:
a wireless transceiver; and
a processor coupled to the wireless transceiver configured to:
obtain at least a portion of a first downlink signal received at the wireless transceiver from a first cell transceiver, the first cell transceiver transmitting the first downlink signal using a one or two antenna port configuration, the first downlink signal comprising a positioning reference signal (PRS); and
selectively affect processing of the PRS of the first downlink signal in a presence of one or more second cell transceivers transmitting a second downlink signal using a four antenna port configuration.

8. The UE of claim 7, wherein the second downlink signal comprises a cell-specific reference signal (CRS) with at least one symbol interfering with at least one symbol of the PRS of the first downlink signal.

9. The UE of claim 7, wherein the processor is configured to selectively affect processing of the PRS of the first downlink signal by applying a processing to the PRS of the first downlink signal as if the PRS of the first downlink signal is transmitted using the four antenna port configuration.

10. The UE of claim 9, wherein applying the processing to the PRS of the first downlink signal as if the PRS of the first downlink signal is transmitted using the four antenna port configuration further comprises ignoring, blanking or not processing at least one symbol in the PRS of the first downlink signal that is not included in a PRS transmitted using the four antenna port configuration.

11. The UE of claim 7, wherein the processor is further configured to:
determine a first received signal strength, wherein the first received signal strength is determined from the first downlink signal; and
determine a second received signal strength, wherein the second received signal strength is determined from signals received from the one or more second cell transceivers; and
selectively applying the processing to the PRS of the first downlink signal as if the PRS of the first downlink signal is transmitted in a downlink signal using the four antenna port configuration based, at least in part, on a comparison of the first received signal strength and the second received signal strength.

12. The UE of claim 11, wherein the comparison comprises a determination of whether a difference between the first received signal strength and the second received signal strength exceeds a threshold value.

13. A non-transitory storage medium comprising computer readable instructions stored thereon which are executable by a processor of a user equipment (UE) to:
obtain at least a portion of a first downlink signal received at the UE from a first cell transceiver, the first cell transceiver transmitting the first downlink signal using a one or two antenna port configuration, the first downlink signal comprising a first positioning reference signal (PRS); and
selectively affect processing of the PRS of the first downlink signal in a presence of one or more second cell transceivers transmitting a second downlink signal using a four antenna port configuration.

14. The non-transitory storage medium of claim 13, wherein the second downlink signal comprises a cell-specific reference signal (CRS) with at least one symbol interfering with at least one symbol of the PRS of the first downlink signal.

15. The non-transitory storage medium of claim 13, wherein the instructions are further executable by the processor to selectively affect processing of the PRS of the first downlink signal by applying a processing to the PRS of the first downlink signal as if the PRS of the first downlink signal is transmitted using the four antenna port configuration.

16. The non-transitory storage medium of claim 15, wherein the instructions are further executable to apply the processing to the PRS of the first downlink signal as if the PRS of the first downlink signal is transmitted using the four antenna port configuration further comprises ignoring, blanking or not processing at least one symbol in the PRS of the first downlink signal that is not included in a PRS transmitted using the four antenna port configuration.

17. The non-transitory storage medium of claim 13, wherein the instructions are further executable by the processor to:
determine a first received signal strength, wherein the first received signal strength is determined from the first downlink signal; and
determine a second received signal strength, wherein the second received signal strength is determined from signals received from the one or more second cell transceivers; and
selectively apply the processing to the PRS of the first downlink signal as if the PRS of the first downlink signal is transmitted in a downlink signal using the four antenna port configuration based, at least in part, on a comparison of the first received signal strength and the second received signal strength.

18. The non-transitory storage medium of claim 17, wherein the comparison comprises a determination of whether a difference between the first received signal strength and the second received signal strength exceeds a threshold value.

19. A user equipment (UE) comprising:
means for receiving a first downlink signal from a first cell transceiver, the first cell transceiver transmitting the first downlink signal using a one or two antenna port configuration, the first downlink signal comprising a first positioning reference signal (PRS); and
means for selectively affecting processing of the PRS of the first downlink signal in a presence of one or more second cell transceivers transmitting a second downlink signal using a four antenna port configuration.

20. The UE of claim 19, wherein the second downlink signal comprises a cell-specific reference signal (CRS) with at least one symbol interfering with at least one symbol of the PRS of the first downlink signal.

21. The UE of claim 19, wherein the means for selectively affecting processing of the PRS of the first downlink signal comprises means for applying a processing to the PRS of the first downlink signal as if the PRS of the first downlink signal is transmitted using the four antenna port configuration.

22. The UE of claim 21, wherein the means for applying the processing to the PRS of the first downlink signal as if the PRS of the first downlink signal is transmitted using the four antenna port configuration further comprises means for ignoring, blanking or not processing at least one symbol in the PRS of the first downlink signal that is not included in a PRS transmitted using the four antenna port configuration.

23. The UE of claim 19, and further comprising:
means for determining a first received signal strength, wherein the first received signal strength is determined from the first downlink signal; and
means for determining a second received signal strength, wherein the second received signal strength is determined from signals received from the one or more second cell transceivers; and
means for selectively applying the processing to the PRS of the first downlink signal as if the PRS of the first downlink signal is transmitted in a downlink signal using the four antenna port configuration based, at least in part, on a comparison of the first received signal strength and the second received signal strength.

24. The UE of claim 23, wherein the comparison comprises a determination of whether a difference between the first received signal strength and the second received signal strength exceeds a threshold value.
